(19) United States
(12) Patent Application Publication
(10) Pub. No.: US 2019/0163360 A1
(43) Pub. Date: May 30, 2019

(54) ELECTRONIC APPARATUS AND METHOD OF CONTROLLING THE SAME

(71) Applicant: Samsung Electronics Co., Ltd., Suwon-si (KR)

(72) Inventors: Won-pil KIM, Suwon (KR); Dae-hyun NAM, Anyang (KR); Min-kyung YOON, Suwon (KR); Jae-eun CHEONG, Yangju (KR)

(73) Assignee: Samsung Electronics Co., Ltd., Suwon-si (KR)

(21) Appl. No.: 16/320,832

(22) PCT Filed: May 9, 2017
(86) PCT No.: PCT/KR2017/004782

§ 371 Date: Jan. 25, 2019

(30) Foreign Application Priority Data
Jul. 26, 2016 (KR) 10-2016-0094567

(51) Int. Cl. G06F 3/0488; G06F 3/0484; H04N 21/422; H04N 21/485; G06F 3/0482

(52) U.S. Cl. CPC G06F 3/04883; G06F 3/0484; H04N 21/42224; G06F 2203/04806; G06F 3/0482; G06F 2203/04808; H04N 21/485

(57) ABSTRACT

Disclosed are an electronic apparatus and method of controlling the electronic apparatus. The electronic apparatus may comprises a touch input receiver comprising a touch area configured to receive a touch input; and a controller configured to, based on a first touch input corresponding to one of the plurality of touch positions designated within the touch area being received, control the electronic apparatus to perform an operation corresponding to the one touch position, and based on a second touch input of a motion that moves from a first touch position to a second touch position among the plurality of touch positions being received, control the electronic apparatus to perform an operation corresponding to the motion of the second touch input.

### TECHNICAL FIELD

The disclosure relates to an electronic apparatus and a method of controlling the same, and more particularly to an electronic apparatus capable of receiving a touch input and a method of controlling the same.

### BACKGROUND ART

With widespread use of a user touch input method as an input means for an electronic apparatus, the touch input method has been introduced even to a television (TV), a monitor, and the like electronic apparatus. For example, a user input part provided in the form of a button that can be directly pushed by a user and allowing the user to make a selective input for channel control, volume control, brightness control, etc. in the existing TV and monitor has been replaced by the touch input method as the touch input method is popularized.

However, the touch input method introduced to the user input part provided in the form of the button has been ended in merely replacing the existing button with a touch sensor. In other words, the touch input method cannot do more than just replace the existing pushbutton.

### DISCLOSURE

### Technical Problem

Accordingly, an object of the disclosure is to make an electronic apparatus introducing a touch input method more variously supporting the touch input method.

### Technical Solution

The foregoing object of the disclosure is achieved by providing an electronic apparatus comprising: a touch input receiver comprising a touch area configured to receive a touch input; and a controller configured to: based on a first touch input corresponding to one of the plurality of touch positions designated within the touch area being received, control the electronic apparatus to perform an operation corresponding to the one touch position, and based on a second touch input of a motion that moves from a first touch position to a second touch position among the plurality of touch positions being received, control the electronic apparatus to perform an operation corresponding to the motion of the second touch input.

The electronic apparatus may further comprises a signal receiver configured to receive a broadcast signal of a plurality of channels, wherein the controller carries out an operation to control at least one of a channel jumping-over degree or a volume according to a speed of the second touch input.

The operation corresponding to the motion of the second touch input may be identified based on the first touch position.

The controller may be configured to control an operation corresponding to a motion of a third touch input to be carried out based on the third touch input of the motion that starts from the first touch position, passes through the second touch position and returns to the first touch position being received.

The controller may be configured to control an operation corresponding to a motion of a fourth touch input to be carried out based on the fourth touch input of the motion that moves to the second touch position starting from a touch that touches plural points of the first touch position being received.

The electronic apparatus may further comprises a display configured to display an image, wherein the touch input receiver is positioned around the display.

The display may comprise a touch screen to display a user interface (UI) to receive a fifth touch input.

The controller may control the electronic apparatus to perform an operation corresponding to a first point of the touch screen and the motion of the second touch input based on the second touch input being received in the touch input receiver while the first point is touched.

The foregoing object of the disclosure is also achieved by providing a method of controlling an electronic apparatus, the method comprising: receiving a touch input corresponding a plurality of touch positions designated within a touch area; based on a first touch input corresponding to one of the plurality of touch positions designated within the touch area being received, controlling the electronic apparatus to perform an operation corresponding to the one touch position; and based on a second touch input of a motion that moves from a first touch position to a second touch position among the plurality of touch positions being received, controlling the electronic apparatus to perform an operation corresponding to the motion of the second touch input.

The electronic apparatus may further comprise a signal receiver configured to receive a broadcast signal of a plurality of channels, and the controlling the electronic apparatus to perform an operation corresponding to the motion of the second touch input comprises carrying out an operation to control at least one of a channel jumping-over degree or a volume according to a speed of the second touch input.

The operation corresponding to the motion of the second touch input may be identified based on the first touch position.

The method may further comprises carrying out an operation corresponding to a motion of a third touch input based on the third touch input of the motion that starts from the first touch position, passes through the second touch position and returns to the first touch position being received.

The method may further comprises carrying out an operation corresponding to a motion of a fourth touch input based on the fourth touch input of the motion that moves to the second touch position starting from a touch that touches plural points of the first touch position being received.

The electronic apparatus may further comprise a display, and the method further comprises displaying an image based on the operation of the electronic apparatus on the display.

The display may further comprises a touch screen to display a user interface (UI) to receive a fifth touch input, and the method further comprises carrying out an operation corresponding to a first point of the touch screen and the motion of the second touch input based on the second touch input being received while the first point is touched.

### Advantageous Effects

As described above, according to the disclosure, more various touch input methods are used to control an electronic apparatus, and it is more convenient for a user to control the electronic apparatus.

### DESCRIPTION OF DRAWINGS

FIG. 1 is a view illustrate an example of an electronic apparatus 100 and a touch input according to an embodiment of the disclosure;

FIG. 2 is a block diagram illustrating a configuration of the electronic apparatus 100 according to an embodiment of the disclosure,

FIG. 3 is a view illustrating another example of a touch input portion 201 according to the disclosure,

FIG. 4 is a view illustrating an example of a second touch input according to an embodiment of the disclosure,

FIG. 5 is a view illustrating an example of a third touch input according to an embodiment of the disclosure,

FIG. 6 is a view illustrating an example of a fourth touch input according to an embodiment of the disclosure,

FIG. 7 is a flowchart illustrating a control method of the electronic apparatus 100 according to an embodiment of the disclosure,

FIG. 8 is a view illustrating a channel control operation of the electronic apparatus 100 according to an embodiment of the disclosure,

FIG. 9 is a view illustrating a lookup table between a cannel jumping-over degree and a second touch input speed according to an embodiment of the disclosure,

FIG. 10 is a view illustrating a volume control operation of the electronic apparatus 100 according to an embodiment of the disclosure,

FIG. 11 is a view illustrating another example of a user interface (UI) of a touch input portion 201 in the electronic apparatus 100 according to an embodiment of the disclosure,

FIG. 12 is a block diagram illustrating a detailed configuration of a controller 202 in the electronic apparatus 100 according to an embodiment of the disclosure,

FIG. 13 is a flowchart illustrating detailed operations of the controller 202 in the electronic apparatus 100 according to an embodiment of the disclosure,

FIG. 14 is a block diagram illustrating a configuration of the electronic apparatus 100 according to another embodiment of the disclosure, and

FIG. 15 is a view illustrating an example of the electronic apparatus 100 and the touch input according to another embodiment of the disclosure.

### BEST MODE

Below, embodiments of the disclosure to actualize the foregoing object in detail will be described in detail with reference to accompanying drawings. However, the configurations and functions illustrated in the following exemplary embodiments are not construed as limiting the present inventive concept and the key configurations and functions. In the following descriptions, details about publicly known functions or features will be omitted if it is determined that they cloud the gist of the present inventive concept.

In the following exemplary embodiments, terms ‘first’, ‘second’, etc. are only used to distinguish one element from another, and singular forms are intended to include plural forms unless otherwise mentioned contextually. In the following exemplary embodiments, it will be understood that terms ‘comprise’, ‘include’, ‘have’, etc. do not preclude the presence or addition of one or more other features, numbers, steps, operations, elements, components or combination thereof. In addition, a ‘module’ or a ‘portion’ may perform at least one function or operation, be achieved by hardware, software or combination of hardware and software, and be actualized by at least one processor as integrated into at least one module.

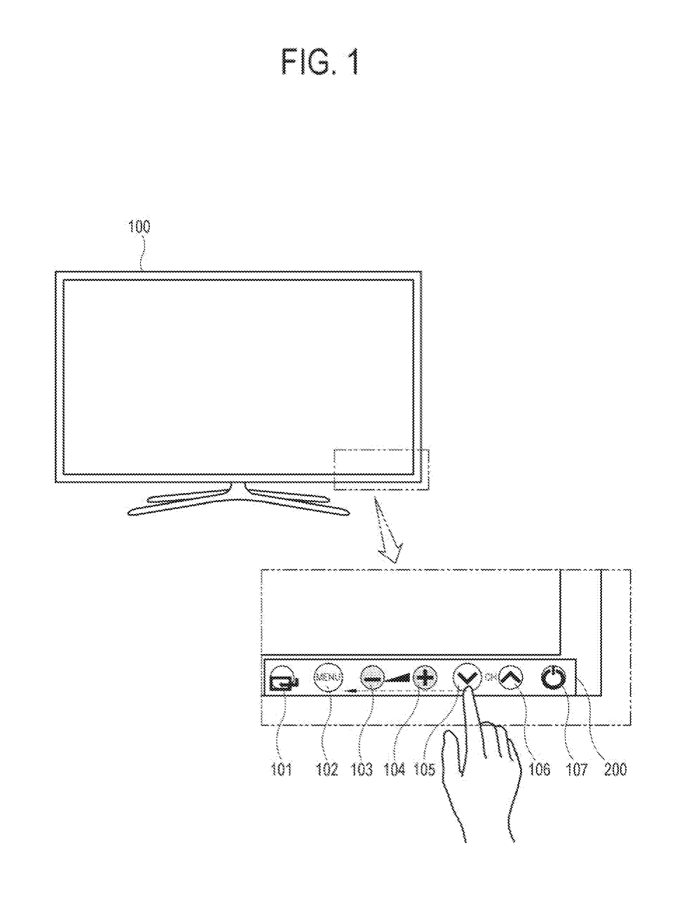

FIG. 1 is a view illustrate an example of an electronic apparatus 100 and a touch input according to an embodiment of the disclosure. The electronic apparatus 100 according to an embodiment of the disclosure may for example actualized by a display apparatus as shown in FIG. 1, and FIG. 1 shows a TV among the display apparatuses. However, without being limited to this embodiment, the electronic apparatus 100 of the disclosure may be actualized by any kind of electronic apparatus such as a large format display (LFD), an MP3 player, an electronic device inside a vehicle, a virtual reality (VR) device, the augmented reality device, a smart watch, etc. or may be actualized by an electronic apparatus having no display.

The electronic apparatus 100 of FIG. 1 includes a touch input portion 201 having a touch area 200 to receive a touch input, and a plurality of touch positions 101˜107 are designated within the touch area 200. When a touch input is received in each of the plurality of touch positions 101˜107, an operation is performed corresponding to each of the touch positions 101˜107, for example, one operation is performed among reception source selection, menu screen display, volume down, volume up, channel down, channel up, and power on/off in a case of FIG. 1. Like this, the touch input made with regard to each of the plurality of touch positions 101˜107 will be called a ‘first touch input’.

Further, according to an embodiment of the disclosure, another touch input may be possible besides the ‘first touch input’ made with regard to each of the plurality of touch positions 101˜107. For example, as shown in FIG. 1, when a user makes a touch input of a motion that starts from a channel-down touch position 105 and is dragged over to a touch position 102, the electronic apparatus 100 of FIG. 1 may carry out an operation corresponding to the motion, i.e. an operation of moving a channel down by three steps. Like this, a touch input of a motion, which moves from a first touch position to a second touch position among the plurality of touch positions 101˜107 designated in the touch area 200, will be called a ‘second touch input’.

Like this, the electronic apparatus 100 according to an embodiment of the disclosure carries out the operation corresponding to each of the touch positions 101˜107 when the first touch input is received, and carries out the operation corresponding to the motion of the second touch input when the second touch input is received.

Meanwhile, the first touch input and the second touch input as described above are merely an example, and there are no limits to the touch input possible that can be made with regard to the electronic apparatus 100 of the disclosure. Another example of the touch input and corresponding operations of the electronic apparatus will be described later in detail.

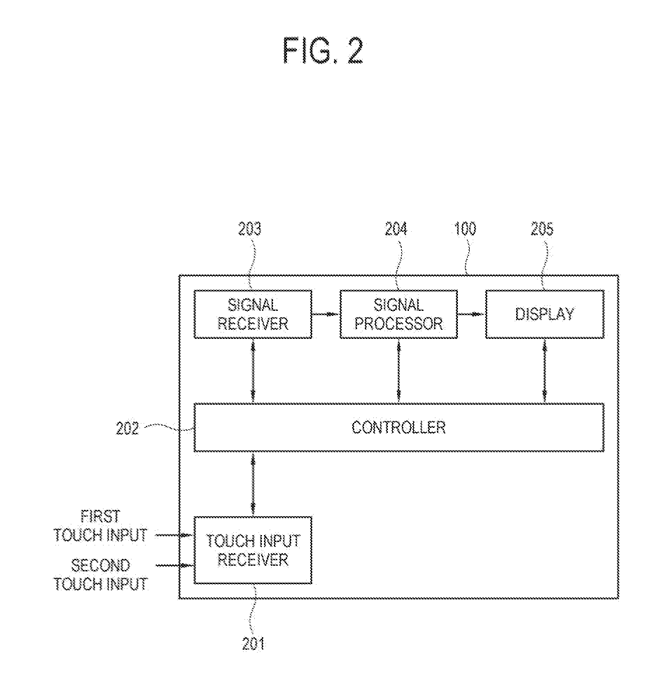

FIG. 2 is a block diagram illustrating a configuration of the electronic apparatus 100 according to an embodiment of the disclosure. The electronic apparatus 100 according to an embodiment of the disclosure includes the touch input portion 201 and the controller 202.

The touch input portion 201 has the touch area 200 for receiving the touch input. The touch input portion 201 may be configured with a pressure sensor or a touch sensor of a capacitive overlay type, a resistive overlay type, an infrared beam type, etc. However, the touch input portion 201 may be actualized by any kind of sensor capable of sensing contact or pressure of an object without limitation. The touch input portion 201 generates a reception signal when a user's touch input is received, and transmits the reception signal to the controller 202.

The plurality of touch positions are designated within the touch area 200 of the touch input portion 201. When a user touches a certain position among the plurality of touch positions, the touch input portion 201 detects where a user touches the touch area 200. This may be achieved by individual touch sensors respectively provided at the touch positions, or may be achieved by using a single touch sensor or fewer touch sensors than the number of touch positions and utilizing information for identifying each touch position. Further, each touch position may, but does not necessarily, be set to correspond to an operation of the electronic apparatus to be carried out when the corresponding touch position is touched. Below, for convenience of description, it will be described on the assumption that the individual touch sensors are respectively provided at the touch positions, and each touch position is set to correspond to the operation of the electronic apparatus to be carried out when the corresponding touch position is touched.

The controller 202 controls general operations of elements such as the touch input portion 201 in the electronic apparatus 100. The controller 202 controls the touch input portion 201 to receive a user's touch input, and recognizes the kind or the like of the touch input received through the touch input portion 201.

The controller 202 may include a nonvolatile memory in which a control program is stored, a volatile memory into which at least a part of the control program is loaded, and a microprocessor for executing the control program. Further, the controller 202 may include two or more microprocessors. For example, the controller 202 may include a main processor for performing main control such as control operations of the controller 202, and an auxiliary processor for performing sub control such as power control, input/output control, etc.

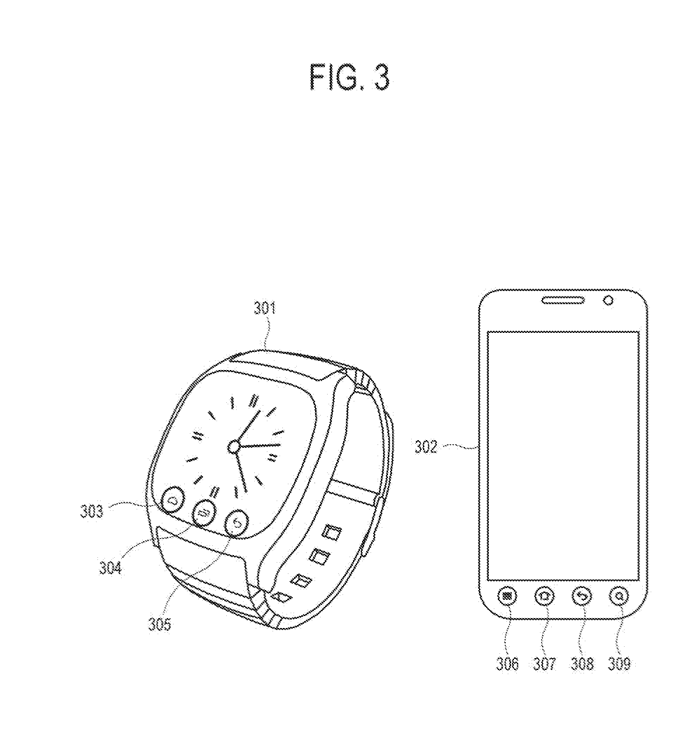

FIG. 3 is a view illustrating another example of a touch input portion 201 according to the disclosure. FIG. 1 shows an example of the touch input portion 201 when the electronic apparatus 100 of the disclosure is a TV. That is, FIG. 1 shows that the touch input portion 201 is positioned in the bezel of the TV, and icons corresponding to one of the operations such as reception image source selection, menu screen display, volume down, volume up, channel down, channel up, and power on/off are respectively displayed for the plurality of touch positions 101˜107 within the touch input portion 201. On the contrary to FIG. 1 showing the TV, FIG. 3 shows an example of a touch input portion when the electronic apparatus 100 of the disclosure is a smart watch 301 or a smart phone 302.

When the electronic apparatus 100 of the disclosure is the smart watch 301, as shown in FIG. 3, the touch input portion may be positioned below a time display area of the smart watch, a plurality of touch positions 303˜305 may be arranged in a row within the touch input portion, and icons corresponding to a home screen, a menu screen, and a go-back operation may be respectively displayed in the touch positions 303˜305. Of course, the position of the touch input portion, the arranged pattern of the touch position within the touch input portion, and the operations respectively corresponding to the touch positions are not limited to this example. For example, the touch input portion of the smart watch may be shaped like a circle or arc positioned at the rim of the time display area, and in this case the touch position may be also arranged in the form of a corresponding circle or arc.

Even when the electronic apparatus 100 of the disclosure is the smart phone 302, as shown in FIG. 3, the touch input portion may be positioned below the screen of the smart phone, a plurality of touch positions 306˜309 may be arranged in a row within the touch input portion, and icons corresponding to a home screen, a menu screen, a go-back operation and a search operation may be respectively displayed in the touch positions 306˜309. Even in this case, of course, the position of the touch input portion, the arranged pattern of the touch position within the touch input portion, and the operations respectively corresponding to the touch positions are not limited to this example. For example, the touch input portion of the smart phone may be positioned at an upper or lateral end of the screen, or a lateral or rear side of the smart phone.

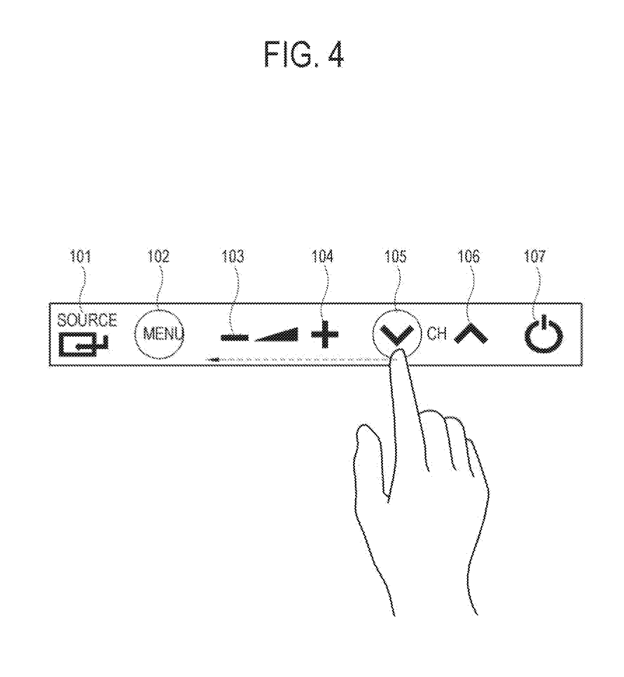

FIGS. 4 to 6 are views illustrating various touch input methods according to an embodiment of the disclosure.

Referring back to FIG. 1 showing an embodiment of the disclosure, in which the electronic apparatus 100 of the disclosure is a TV, the plurality of touch positions 101˜107 are designated in the touch input portion 201. IN this case, of course, touch inputs may be respectively made to the plurality of touch positions 101˜107. Likewise, the touch input to each of the plurality of touch positions 101˜107 will be called the first touch input as described above.

In the disclosure, various touch inputs are possible as well as the first touch input. FIGS. 4 to 6 are examples of the touch inputs, which respectively indicate the second touch input, a third touch input, and a fourth touch input.

FIG. 4 is a view illustrating an example of the second touch input according to an embodiment of the disclosure. As described above, the second touch input refers to the touch input of the motion that moves from the first touch position to the second touch position among the plurality of touch positions 101˜107 designated within the touch input portion 201. For example, as shown in FIG. 4, a user may make a touch input of a motion that touches one touch position 105 of the touch positions and then moves to another touch position 102 while maintaining the touch with the electronic apparatus 100, and the electronic apparatus 100 may receive and recognize the second touch input.

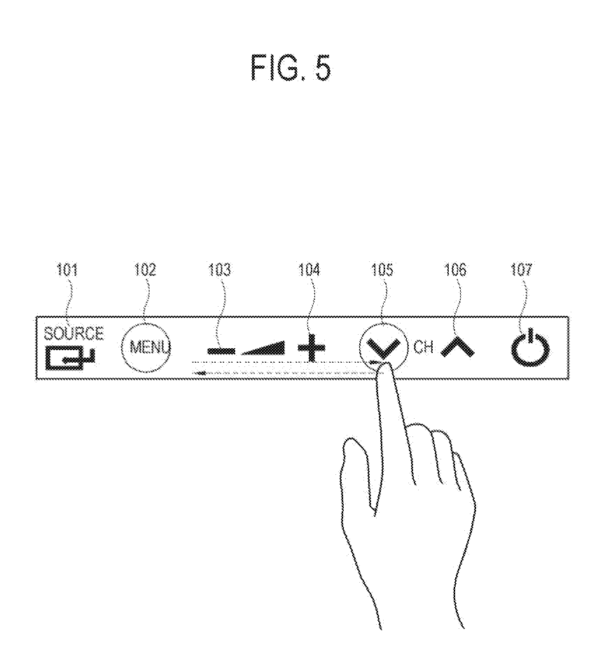

FIG. 5 is a view illustrating an example of the third touch input according to an embodiment of the disclosure. The third touch input refers to a touch input of a motion that moves from the first touch position among the plurality of touch positions 101˜107 designated within the touch input portion 201 to the second touch position and returns to the first touch position. For example, as shown in FIG. 5, a user may make a touch input of a motion that touches one touch position 105 of the touch positions, moves to another touch position 102 while maintaining the touch with the electronic apparatus 100, and returns to the touch position 105, and the electronic apparatus 100 may receive and recognize the third touch input.

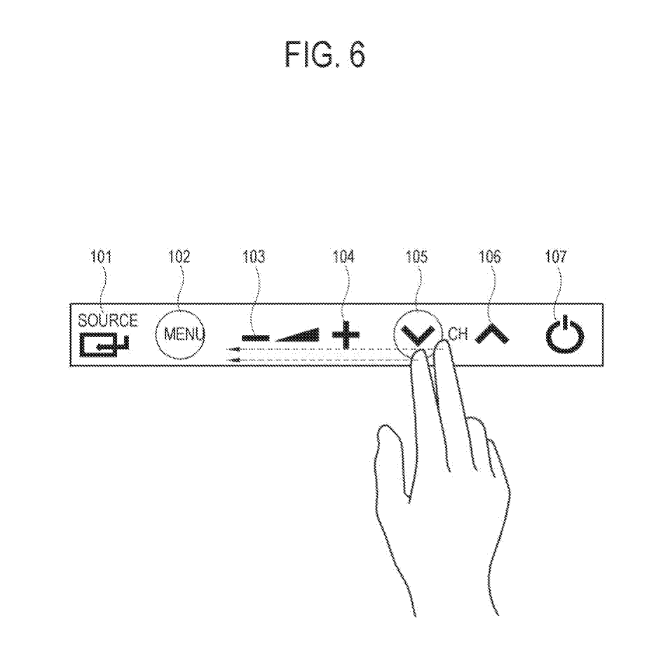

FIG. 6 is a view illustrating an example of a fourth touch input according to an embodiment of the disclosure. The fourth touch input refers to a touch input of a motion that moves to the second touch position from touch with ‘plural’ points in the first touch position among the plurality of touch positions 101˜107 designated within the touch input portion 201. For example, as shown in FIG. 6, a user may make a touch input of a motion that touches plural points in one touch position 105 of the touch positions, and moves to another touch position 102 while maintaining the touches with the plural points in the electronic apparatus 100, and the electronic apparatus 100 may receive and recognize the third touch input.

Like this, according to the disclosure, it is possible to support various touch inputs, and thus have an effect as if the touch sensors individually operating at separate positions serve as a single touch pad. Further, according to the disclosure, more various touch input methods are used to control the electronic apparatus 100, and it is thus more convenient for a user to control the electronic apparatus 100.

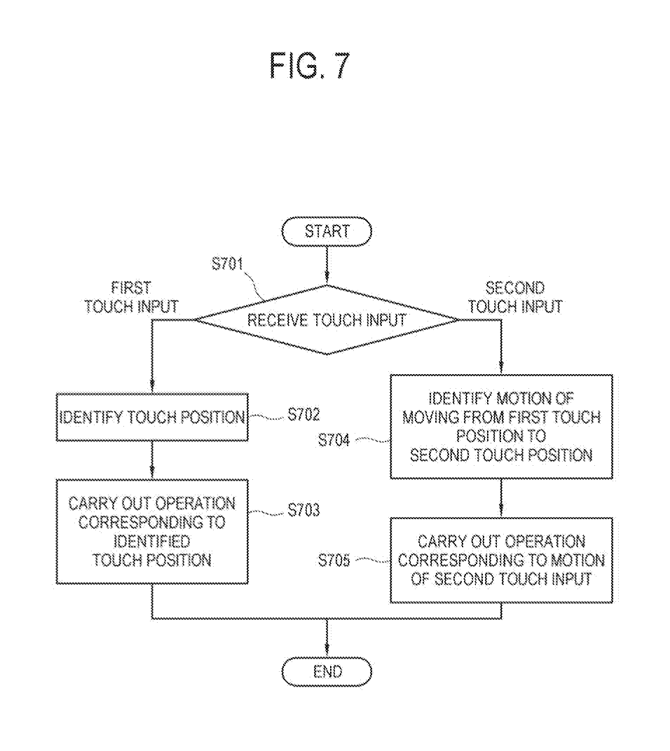

FIG. 7 illustrates a method of controlling the electronic apparatus 100 with various touch input methods according to the disclosure.

First, the controller 202 controls the touch input portion 201 to receive a user's touch input. The touch input portion 201 receives a user's touch input (S701) and generates a reception signal, thereby transmitting the reception signal to the controller 202.

The controller 202 identifies whether the received touch input is the first touch input or the second touch input. When the received touch input is the first touch input, the controller 202 identifies a touch position where the first touch input is made (S702), and controls the electronic apparatus 100 to carry out an operation corresponding to the touch position (S703). When the received touch input is the second touch input, the controller 202 identifies the motion of the second touch input, i.e. the motion that moves from the first touch position to the second touch position (S704), and controls the electronic apparatus 100 to carry out an operation corresponding to the motion of the second touch input (S705).

For convenience of description, FIG. 7 illustrates only the case of receiving the first touch input or the second touch input. Of course, the third touch input and the fourth touch input may be also received. Even in this case, control methods are similar to those for the first touch input and the second touch input in terms of recognizing the touch input and controlling the operation to be carried out corresponding to the recognized touch input.

Referring back to FIG. 2, the electronic apparatus 100 according to an embodiment of the disclosure may further include a signal receiver 203, a signal processor 204, and a display 205. However, the electronic apparatus 100 according to an embodiment of the disclosure is not limited to the configuration shown in FIG. 2, but may exclude at least one element from the elements shown in FIG. 2 or additionally include another element not shown in FIG. 2.

The signal receiver 203 receives a broadcast signal. The signal receiver 203 may receive a broadcast signal from a broadcast signal transmitter of a broadcasting station, or may receive a broadcast signal from a relay apparatus that relays the broadcast signal. The broadcast signal received in the signal receiver 203 may be a wired or wireless signal, a digital or analog signal, a skywave signal, a cable signal, a satellite signal, or a network signal. Further, the signal receiver 203 may additionally include a Wi-Fi communication module for wireless communication, an Ethernet module for separate wired connection, a universal serial bus (USB) port for connection with a USB memory.

The signal receiver 203 may receive a broadcast signal of a certain channel among a plurality of channels under control of the controller 202. The broadcast signal contains broadcast content provided by the broadcasting station. The broadcast content includes various broadcast programs such as drama, movie, news, sports, music, video on demand (VOD), etc. and there are no limits to the content.

The signal processor 204 processes a broadcast signal received in the signal receiver 203. Under control of the controller 202, the signal processor 204 performs a signal process according to the formats of the received broadcast signal and extracts data of broadcast content.

There are no limits to the kind of image processing process performed in the signal processor 204. The image process performed in the signal processor 204 may for example include de-multiplexing for dividing an input stream into sub streams such as video, audio and appended data; decoding corresponding to a video format of a video stream; de-interlacing for converting an interlaced type of a video stream into a progressive type; scaling for adjusting a video stream to have a preset resolution; noise reduction for improving image quality; detail enhancement; frame refresh rate conversion; etc.

The display 205 may display an image based on data of broadcast content extracted by the signal processor 204. There are no limits to the type of the display 205. For example, the display 205 may be actualized by various types such as liquid crystal, plasma, a light emitting diode, an organic light-emitting diode, a surface-conduction electron-emitter, a carbon nano-tube, nano-crystal, etc.

The display 205 may include an additional element in accordance with its types. For example, in a case of the liquid crystal type, the display 205 may include a liquid crystal display panel, a backlight unit for emitting light to the liquid crystal display panel, a panel driving substrate for driving the liquid crystal display panel, etc.

When the electronic apparatus 100 of the disclosure further includes the display 205 as described above, the touch input portion 201 may be arranged around the display 205.

Below, operations of the electronic apparatus 100 having the foregoing configuration and using the foregoing touch input method according to an embodiment of the disclosure will be described by providing concrete examples. It will be described on the assumption that the electronic apparatus 100 is a TV, and the TV includes all the elements shown in FIG. 2 and supports all the touch inputs from the first to fourth touch inputs. In addition, it will be described on the assumption that the plurality of designated touch positions 101˜107 are respectively set to correspond to reception image source selection, menu screen display, volume down, volume up, channel down, channel up, and power ON/OFF.

Operations of when the touch inputs of various methods are received in the electronic apparatus 100 will be described below in sequence. First, when the first touch input is received, i.e. when a user's first touch input is made with regard to a certain touch position among the plurality of designated touch positions 101˜107, the operation of the electronic apparatus 100 is carried out corresponding to the touch position. For example, when a user touches the touch position 105, the operation of changing the channel up one step is carried out.

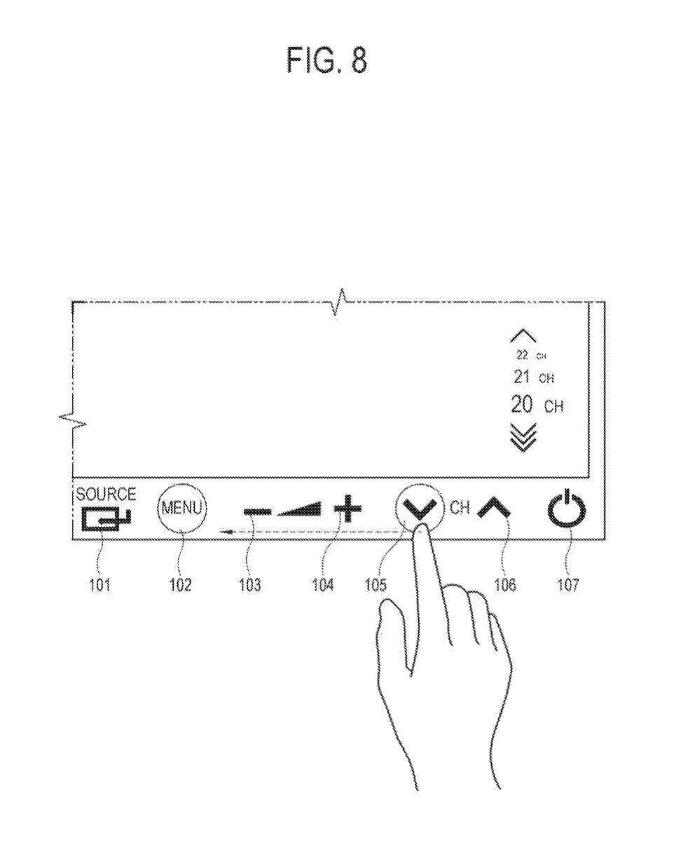

The operation in the case of receiving the second touch input will be described with reference to FIG. 8. FIG. 8 is a view illustrating a channel control operation of the electronic apparatus 100 according to an embodiment of the disclosure. As shown in FIG. 8, when a user makes the second touch input of the motion that moves from the first touch position to the second touch position, i.e. when a user makes the touch input of touching the touch position 105 and then moving to another touch position 102 while maintaining the touch with the electronic apparatus 100, the controller 202 may carry out the operation of controlling at least one of a channel jumping-over degree and a volume in response to the speed of the second touch input. However, the target to be controlled in response to the speed of the second touch input is not limited to the channel or the volume. For example, anything may be controllable based on the speed of the second touch input as long as it has quantitative concept or is numerically representable.

It may be determined by the first touch position whether to control the channel jumping-over degree or the volume in response to the speed of the second touch input. That is, in the case of FIG. 8, the first touch position, which is first touched by a user to make the second touch input, is the touch position 105 and the corresponding operation of the electronic apparatus 100 is the ‘channel down’, and therefore the case of FIG. 8 may be determined as an input for adjusting a ‘degree of changing the channel down’ in accordance with the speed of the second touch input. On the other hand, when the first touch position is the touch position 103, the target to be controlled may be the ‘volume’.

The speed of the second touch input may be varied depending on a distance between the touch positions through which the second touch input passes, and time at which the first touch position and the second touch position are touched. For example, on the assumption that the touch positions are all arranged as equidistantly spaced apart from each other, the speed of the second touch input may be determined based on a value obtained by dividing the number of spaces between the first touch position and the second touch position by time taken in moving the touch from the first touch position to the second touch position. Further, the channel jumping-over degree may be determined corresponding to the speed of the second touch input on the basis of a table where the channel jumping-over degrees are tabulated matching the speeds of the second touch input.

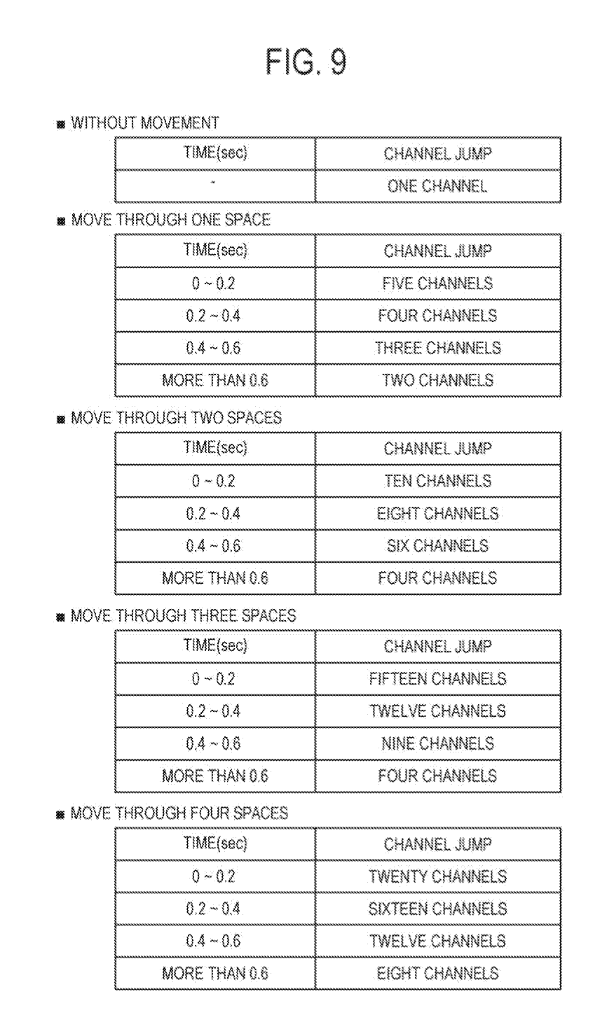

FIG. 9 is a view illustrating an example of a lookup table between a cannel jumping-over degree and a second touch input speed according to an embodiment of the disclosure. The second touch input has a higher speed as moving through more spaces for a shorter time, and therefore the number of channels to be jumped over increases.

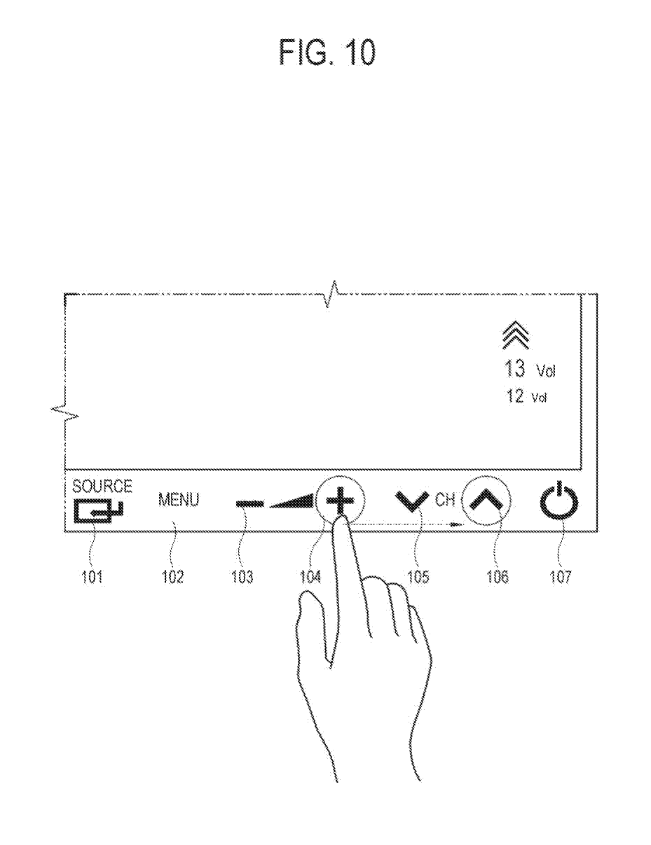

FIG. 10 is a view illustrating a volume control operation of the electronic apparatus 100 according to an embodiment of the disclosure. In a case of FIG. 10, the first touch position, which is first touched by a user to make the second touch input, is the touch position 104 and the corresponding operation of the electronic apparatus 100 is the ‘volume up’, and therefore the case of FIG. 10 may be determined as an input for adjusting a ‘degree of turning the volume up’ in accordance with the speed of the second touch input. The degree of volume to be adjusted in accordance with the speed of the second touch input may be determined based on a lookup table like that of FIG. 9.

To simplify the method of determining the adjustment degree, the adjustment degree may be determined based on the number of spaces via which the second touch input moves. Such examples are depicted in FIGS. 8 and 10. In the case of FIG. 8, the second touch input for changing the channel down moves by three spaces from the touch position 105 to the touch position 102, and thus control is made to jump over the channel down by three steps from No. 23 to No. 20. In the case of FIG. 10, the second touch input for turning the volume up moves by two spaces from the touch position 104 to the touch position 106, and thus control is made to jump over the volume by two steps from ‘11’ to ‘13’.

When the third touch input is received, the operation of the electronic apparatus 100 may include various operations corresponding to the third touch input. For example, when the third touch input is received, a ‘previous operation cancel’ operation may be carried out. In more detail, for example, as shown in FIG. 10, when a user makes the third touch input of starting from the touch position 106 and returning to the touch position 106 via the touch position 104 after the volume increases by two steps as the user makes the second touch input of moving from the touch position 104 to the touch position 106, the ‘previous operation cancel’ operation may be carried out to thereby cancel the previous operation, i.e. the operation by which the volume has been increased by two steps.

When the fourth touch input is received, the operation of the electronic apparatus 100 may also include various operations corresponding to the fourth touch input. Because the fourth touch input corresponds to an operation of moving to the second touch position from touch with ‘plural’ points of the first touch position, a user can use many fingers to make the fourth touch input like the second touch input. Accordingly, a matching operation may be similar to the operation corresponding to the second touch input but different in that its adjustment degree is multiplied in accordance with the number of used fingers. For example, when the motion of the second touch input shown in FIG. 10 is made with two fingers, i.e. the fourth touch input is received, an operation may be carried out to control the volume by four steps (=the two-step volume control×2).

According to an embodiment of the disclosure, an operation or interface of the electronic apparatus 100 corresponding to a plurality of touch positions designated within the touch input portion 201 may be newly configured to support various touch input methods.

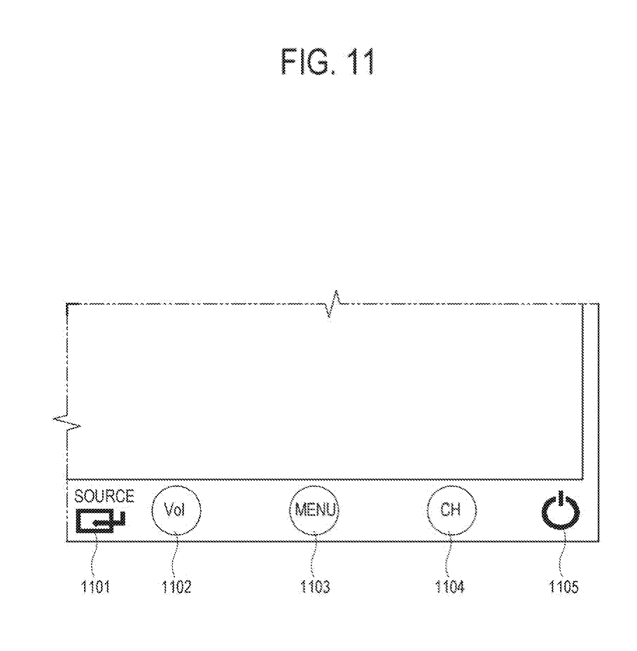

FIG. 11 is a view illustrating another example of a user interface (UI) of a touch input portion 201 in the electronic apparatus 100 according to an embodiment of the disclosure. The operation of the electronic apparatus 100 corresponding to the touch input method, e.g. the second touch input method of the disclosure may be determined based on the first touch position from which the second touch input starts as described above, or may be further determined based on the direction of the second touch input. For example, in a case where a user makes the second touch input starting from the first touch position related to the ‘volume’, an operation may be determined to turn the volume up when the motion of the second touch input is made in a right direction and to turn the volume down when the motion of the second touch input is made in a left direction.

In this case, it is enough to show that the first touch position is related to the ‘volume’, and there are no needs to set the touch positions respectively corresponding to ‘volume up’ and ‘volume down’. Therefore, as shown in FIG. 11, only one touch position 1102 corresponding to the volume and only one touch position 1104 corresponding to the channel are provided. Further, such two touch positions are respectively arranged on both sides of the touch input portion 201 with respect to the middle of the touch input portion 201, thereby not only making it easy to distinguish between the touch input for volume control and the touch input for channel control but also sufficiently securing a movable distance of the second touch input starting from each touch position.

A detailed configuration and operations of the electronic apparatus 100 for controlling at least one of the channel jumping-over degree and the volume in response to the speed of the second touch input are as follows.

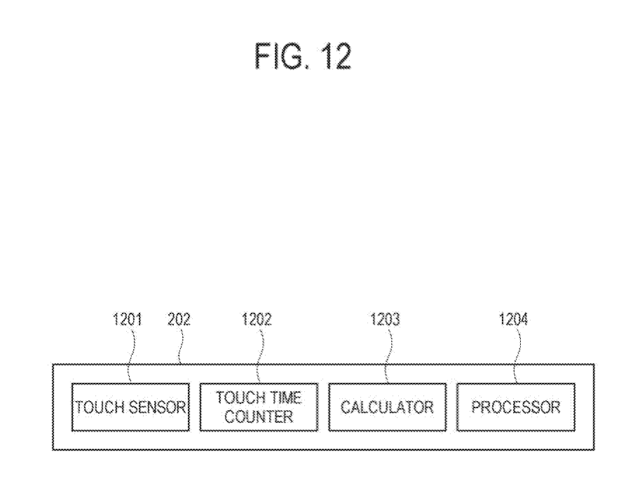

FIG. 12 is a block diagram illustrating a detailed configuration of the controller 202 in the electronic apparatus 100 according to an embodiment of the disclosure, which controls at least one of the channel jumping-over degree and the volume in response to the speed of the second touch input. As shown in FIG. 12, the controller 202 may include a touch sensor 1201, a touch time counter 1202, a calculator 1203, and a processor 1204.

The touch sensor 1201 senses a user's touch input to a plurality of designated touch positions of the touch input portion 201.

The touch time counter 1202 counts time of a user's touch sensed by the touch sensor 1201 from the start of the touch to the finish of the touch.

The calculator 1203 calculates the speed of the second touch input based on the time of the touch input and a moving distance of the touch. The time of the touch input is obtained based on the time counted by the touch time counter 1202, and the moving distance of the touch is obtained based on the start and finish points of the touch input sensed by the touch sensor 1201.

The calculator 1203 determines the operation of the electronic apparatus 100 based on the speed of the second touch input calculated as above. Of course, the operation may be also determined through the lookup table as shown in FIG. 9.

The processor 1204 actually carries out and processes the operation of the electronic apparatus 100 determined in the calculator 1203.

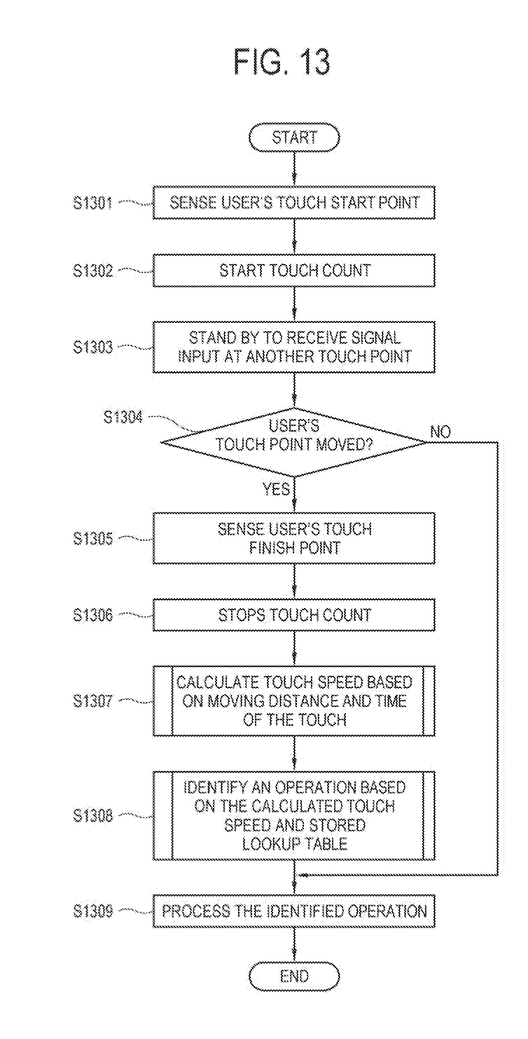

FIG. 13 is a flowchart illustrating detailed operations of the foregoing elements.

When a user's touch input starts, the touch sensor 1201 senses a touch position at which the user's touch input starts (S1301). The touch time counter 1202 starts counting time (S1302).

All the second to fourth touch inputs except the first touch input are moved to another touch position after touching the start touch position. Therefore, the touch sensor 1201 is on standby to sense whether a touch signal is input to another touch position even when a user's touch input is sensed at one touch position (S1303). With this, it is possible to determine whether a user's touch position is moved (S1304).

When the touch signal is not input to another touch position, i.e. when a user's touch position is not moved, this corresponds to the first touch input, i.e. one touch of a certain touch position, and therefore the processor 1204 directly carries out the operation of the electronic apparatus 100 in response to the corresponding touch position.

On the other hand, when the touch position moves, the touch sensor 1201 senses the moved touch position and the touch-finished touch position (S1305). Further, the touch time counter 1202 stops counting in time for the touch finish (S1306).

Then, the calculator 1203 calculates the speed of the second touch input based on the start and finish touch positions sensed by the touch sensor 1201, and touch time counted by the touch time counter 1202 (S1307), and determines the corresponding operation of the electronic apparatus 100 (S1308).

The processor 1204 actually carries out and processes the operation of the electronic apparatus 100 determined as above (S1309).

Although the detailed configuration and operations of the electronic apparatus 100 for controlling at least one of the channel jumping-over degree and the volume in response to the speed of the second touch input are described with reference to FIGS. 12 and 13, such features are also applicable to the third touch input and the fourth touch input as well as the second touch input, and the targets to be controlled are not limited to the channel jumping-over degree or the volume.

Below, another embodiment of the disclosure will be described. As an alternative to the foregoing embodiments, the electronic apparatus 100 according to this embodiment of the disclosure is related to a smart phone.

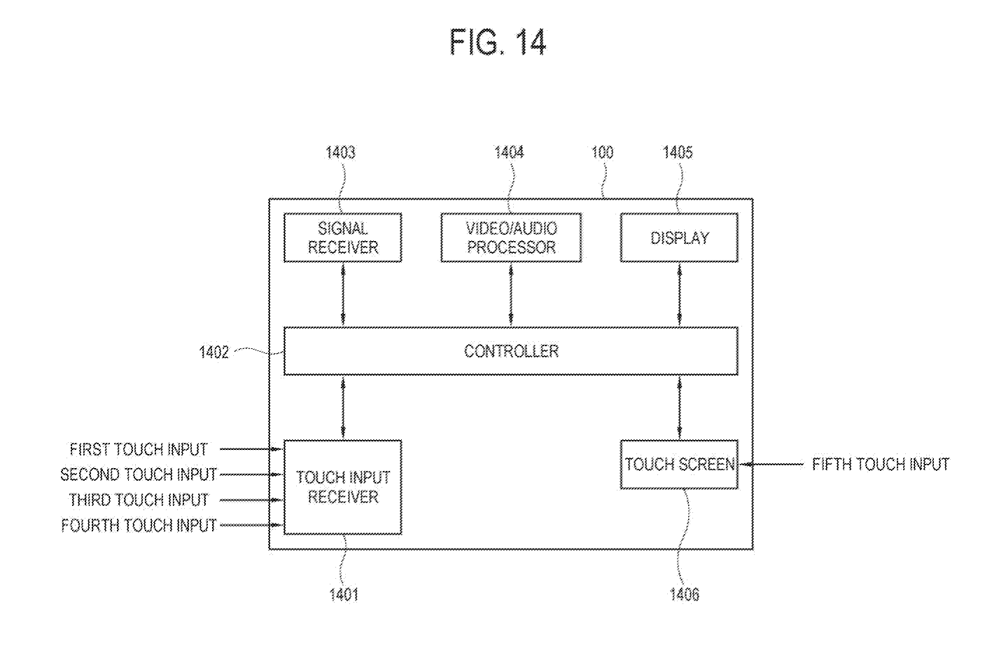

FIG. 14 is a block diagram illustrating a configuration of the electronic apparatus 100 according to another embodiment of the disclosure. According to another embodiment of the disclosure, the electronic apparatus 100, i.e. the smart phone may include a touch input portion 1401, a controller 1402, a signal receiver 1403, a video/audio processor 1404, a display 1405, and a touch screen 1406. Among them, the touch input portion 1401, the controller 1402, the signal receiver 1403 and the display 1405 are equivalent to the touch input portion 201, the controller 202, the signal receiver 203 and the display 205 as described above, and therefore repetitive descriptions thereof will be avoided. The video/audio processor 1404 is also equivalent to the signal processor 204 as described above except for processing a sound as well as an image, and therefore repetitive descriptions thereof will be avoided.

The touch screen 1406 is installed on the surface of the display 1405 and senses a user's touch input to the display 1405. The touch screen 1406 may be configured with a pressure sensor or a touch sensor of a capacitive overlay type, a resistive overlay type, an infrared beam type, etc. However, the touch screen 1406 may be actualized by any kind of sensor capable of sensing contact or pressure of an object without limitation. The touch screen 1406 generates a reception signal when a user's touch input is received, and transmits the reception signal to the controller 1402.

The touch screen 1406 is a separate element from the touch input portion 1401, and receives a fifth touch input different from the first to fourth touch inputs receivable in the touch input portion 1401. The fifth touch input may include various touch input to a touch screen, for example, a tap, a double tap, drag, drag and drop, a pinch zoom in/out, multi-touch drag for rotating a screen, etc. The touch screen 1406 may display a UI for receiving the foregoing fifth touch input.

The touch input using both the touch screen 1406 and the touch input portion 1401 is also possible. That is, the electronic apparatus 100 according to another embodiment of the disclosure may be controlled by making one of the first to fourth touch inputs to the touch input portion 1401 while the fifth touch input is made on the touch screen 1406.

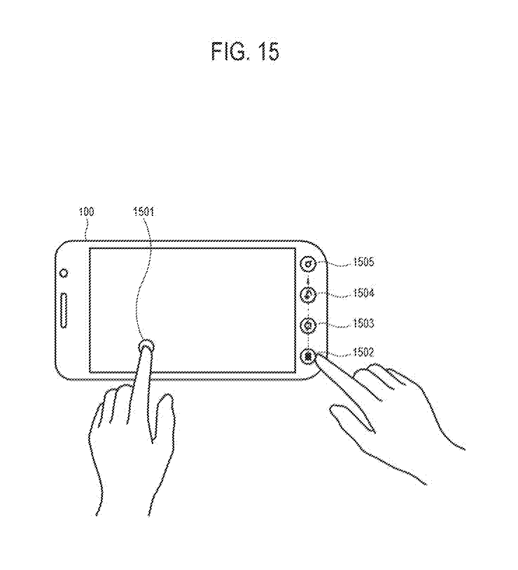

FIG. 15 is a view illustrating an example of a touch input using both the touch screen 1406 and the touch input portion 1401. As shown in FIG. 15, the electronic apparatus 100 according to another embodiment of the disclosure, i.e. the smart phone may carry out an operation corresponding to the motion of the second touch input and the first point, when the second touch input (i.e. the touch input of the motion that moves from the touch position 1502 to the touch position 1504) is received in the touch input portion 1401 while the first point 1501 of the touch screen 1406 is touched.

As above, the touch input using both the touch screen 1406 and the touch input portion 1401 is utilizable in various jobs. For example, in a case where a moving picture is being played back in the smart phone and it is possible to control a sound at a specific point of the played screen to be distinguishable from a sound at a different point because the moving picture is recorded and generated using multi-microphones, when a user makes the second touch input of turning the volume up with one hand on the touch input portion 1401 while touching the first point 1501 of the touch screen 1406 with the other hand, it is possible to turn up only the volume of the sound at the point corresponding to the first point 1501 on a moving picture screen.

Like this, when the touch input using both the touch screen 1406 and the touch input portion 1401 is utilized, various inputs, which are impossible or difficult for the touch input using only the touch screen 1406 or the touch input using only the touch input portion 1401, are allowed, thereby controlling the electronic apparatus 100 through more various methods.

Although the disclosure has been described by the limited embodiments and drawings, various modifications and changes can be made from the foregoing descriptions by a person having an ordinary skill in the art. For example, proper results are achieved even though the described features are carried out in order different from that of the foregoing method, or the elements of the described system, structure, apparatus, circuit, etc. may be coupled or assembled in a form different from that of the foregoing method, or may be replaced or substituted by other elements or equivalents. Accordingly, the disclosure is not restricted by the foregoing embodiments and accompanying drawings, but involves other actualizations, embodiments, appended claims and equivalents, and the methods of the disclosure are taken into account for not restrictive but illustrative purpose.

1. An electronic apparatus comprising:
a touch input receiver comprising a touch area configured to receive a touch input; and
a controller configured to:
based on a first touch input corresponding to one of the plurality of touch positions designated within the touch area being received, control the electronic apparatus to perform an operation corresponding to the one touch position, and
based on a second touch input of a motion that moves from a first touch position to a second touch position among the plurality of touch positions being received, control the electronic apparatus to perform an operation corresponding to the motion of the second touch input.

2. The electronic apparatus according to claim 1, further comprising a signal receiver configured to receive a broadcast signal of a plurality of channels,
wherein the controller carries out an operation to control at least one of a channel jumping-over degree or a volume according to a speed of the second touch input.

3. The electronic apparatus according to claim 1, wherein the operation corresponding to the motion of the second touch input is identified based on the first touch position.

4. The electronic apparatus according to claim 1, wherein the controller is configured to control an operation corresponding to a motion of a third touch input to be carried out based on the third touch input of the motion that starts from the first touch position, passes through the second touch position and returns to the first touch position being received.

5. The electronic apparatus according to claim 1, wherein the controller is configured to control an operation corresponding to a motion of a fourth touch input to be carried out based on the fourth touch input of the motion that moves to the second touch position starting from a touch that touches plural points of the first touch position being received.

6. The electronic apparatus according to claim 1, further comprising a display configured to display an image,
wherein the touch input receiver is positioned around the display.

7. The electronic apparatus according to claim 6, wherein the display comprises a touch screen to display a user interface (UI) to receive a fifth touch input.

8. The electronic apparatus according to claim 7, wherein the controller controls the electronic apparatus to perform an operation corresponding to a first point of the touch screen and the motion of the second touch input based on the second touch input being received in the touch input receiver while the first point is touched.

9. A method of controlling an electronic apparatus, the method comprising:
receiving a touch input corresponding a plurality of touch positions designated within a touch area;
based on a first touch input corresponding to one of the plurality of touch positions designated within the touch area being received, controlling the electronic apparatus to perform an operation corresponding to the one touch position; and
based on a second touch input of a motion that moves from a first touch position to a second touch position among the plurality of touch positions being received, controlling the electronic apparatus to perform an operation corresponding to the motion of the second touch input.

10. The method according to claim 9, wherein the electronic apparatus further comprises a signal receiver configured to receive a broadcast signal of a plurality of channels, and
the controlling the electronic apparatus to perform an operation corresponding to the motion of the second touch input comprises carrying out an operation to control at least one of a channel jumping-over degree or a volume according to a speed of the second touch input.

11. The method according to claim 9, wherein the operation corresponding to the motion of the second touch input is identified based on the first touch position.

12. The method according to claim 9, further comprising carrying out an operation corresponding to a motion of a third touch input based on the third touch input of the motion that starts from the first touch position, passes through the second touch position and returns to the first touch position being received.

13. The method according to claim 9, wherein further comprising carrying out an operation corresponding to a motion of a fourth touch input based on the fourth touch input of the motion that moves to the second touch position starting from a touch that touches plural points of the first touch position being received.

14. The method according to claim 9, wherein
the electronic apparatus further comprises a display, and
the method further comprises displaying an image based on the operation of the electronic apparatus on the display.

15. The method according to claim 14, wherein
the display further comprises a touch screen to display a user interface (UI) to receive a fifth touch input, and
the method further comprises carrying out an operation corresponding to a first point of the touch screen and the motion of the second touch input based on the second touch input being received while the first point is touched.
